(19) United States
(12) Patent Application Publication
(10) Pub. No.: US 2022/0364693 A1
(43) Pub. Date: Nov. 17, 2022

(54) TEST DEVICE, SYSTEM AND METHOD WITH SUN LIGHT SIMULATION

(71) Applicant: POLITECNICO DI TORINO, Torino (IT)

(72) Inventor: Leonardo REYNERI, Torino (IT)

(73) Assignee: POLITECNICO DI TORINO, Torino (IT)

(21) Appl. No.: 17/766,544

(22) PCT Filed: Oct. 22, 2020
(86) PCT No.: PCT/IB2020/059951

§ 371 Date: Apr. 5, 2022

(30) Foreign Application Priority Data
Oct. 22, 2019 (IT) 102019000019565

(51) Int. Cl. F21S 8/00; H05B 39/04

(52) U.S. Cl. CPC F21S 8/006; H05B 39/041

(57) ABSTRACT

A device, a system, and a method for simulating sunlight by reducing operating costs and maintaining relatively high accuracy through the use of a low-cost light source and a modified light source power supply conversion table. The illuminating device includes: at least one incandescent light source at a temperature not exceeding 5000K; at least one station, which receives light from the at least one the incandescent light source and has a support to support a small body to be illuminated; an electronic control unit, for variable powering of the incandescent light source and including at least one electronic processing device (a microprocessor and a memory device connected in data exchange with the microprocessor); and a control unit programmed for receiving construction data of the small body and the atmosphere, storing the reference table for power supply conversion, and powering the incandescent light source based on the reference table.

### CROSS REFERENCE TO THE RELATED APPLICATIONS

This application is the national phase entry of International Application No. PCT/IB2020/059951, filed on Oct. 22, 2020, which is based upon and claims priority to Italian Patent Application No. 102019000019565, filed on Oct. 22, 2019, the entire contents of which are incorporated herein by reference.

### TECHNICAL FIELD

The present invention relates to a device and a method for simulating sunlight in at least two conditions of atmospheric effects different between AM0, AM1, and AM1.5 in a reasonably precise and inexpensive way.

### BACKGROUND

It is known to simulate sunlight using expensive lamps, such as Xenon lamps, to illuminate objects intended for use in earth orbit and/or space such as satellites and photovoltaic cells for satellites. Recently, commercial space missions for sending private devices into space not exclusively for research purposes have been growing. The very high cost of these missions favors the miniaturization of devices, and the need has arisen to perform simulations of solar lighting of these space objects at more limited costs, taking advantage of the smaller size compared to that of the devices dedicated to institutional space missions and to which public funds are dedicated.

Furthermore, in the school environment, especially in the Italian upper secondary school and equivalent in other countries and during university courses, the simulation of solar lighting in atmospheric conditions different from those of the earth's surface is useful for carrying out practical exercises for students.

### SUMMARY

The object of the present invention is to provide a device, a system, and a method for simulating sunlight in at least two different conditions of atmospheric effects capable of being sufficiently precise and inexpensive.

The object of the present invention is achieved by means of a device according to claim 1 which uses inexpensive lamps and is very precise when the simulation is performed with the same bodies used for the compilation of the reference table for the supply voltage of low-cost lamps. When the body objects of the simulation are different, the level of precision is still acceptable.

According to a preferred but non-limiting embodiment, the device also comprises a frame configured to allow the modular aggregation of multiple devices, e.g., in order to illuminate objects having an intermediate size and therefore not suitable for a single lighting device. In this case, each module is powered on the basis of what is reported in the reference table.

Incandescent light has a different spectrum from that of the sun both in standard AM0 conditions and in standard AM1 conditions, with the same illuminance (measured in lux). In particular, incandescent light has a lower contribution of ultraviolet radiation and a greater contribution of infrared radiation. This impacts both on the different heating of colored surfaces and on the efficiency of the photovoltaic cells normally arranged on board the space or orbital devices being simulated.

The present invention applies a pragmatic approach which provides for the preparation of a reference table in which, for each physical-chemical surface parameter of an object to be tested, a power supply of the incandescent light source with light temperature lower than 5000K, for example halogen, is associated, which overall produces the effect equivalent to that of a light source, e.g., Xenon arc, with a frequency spectrum equal to that of sunlight in thermal, photoelectric or chemical fields. The preparation of the reference table is performed for example in a calibration laboratory in which a desired number of physico-chemical parameters are tested in sequence in the various areas of interest, e.g., thermal, photoelectric, and chemical, on different objects with various constructive characteristics. For example, a reference table is generated for each area of interest.

The reference table is subsequently made accessible to the control unit of the test device of the present invention which also comprises a user interface through which, for a specific object to be tested, the user enters the relative chemical-physical parameters and the effect to be monitored so that, using the reference table, the incandescent light source with a light temperature below 5000K, is supplied with the power suitable to induce the effect equivalent to that of the frequency spectrum of sunlight.

The input data preferably also includes the identification of the atmospheric lighting conditions, for example AM0, AM1.5 and AM1. Correspondingly, for example, there is a reference table for each of these lighting conditions. Alternatively, the lighting table is multidimensional in order to consider the various categories of input data, i.e., the chemical-physical surface characteristics of the object to be illuminated, the scope of the measurement e.g., thermal, electrochemical, or chemical, and atmospheric conditions.

The use of incandescent light sources with light at a temperature below 5000K allows for a continuous spectrum of frequencies and low costs, especially if halogen lamps are used. In fact, the continuous spectrum is particularly suitable for testing triple junction solar cells, capable of absorbing light of numerous frequencies.

In addition, the approach of providing an equivalent radiation different from that of compensating the results allows for the testing of complex objects, such as systems complete with solar cells, converters and batteries. In fact, compensation is based on mathematical models that are suitable and very precise only in the case of simple objects or geometries.

When the light sources are halogen, in addition to low costs, the lower contribution in the UV frequencies of the spectrum is less harmful to the eyes and this is particularly noticeable in use for students.

According to a preferred embodiment, the configuration of the device is modular and preferably comprises an external casing surrounding a plurality of point light sources, in which the distance between the respective optical axes of each point source surrounded by the external casing is constant even when it is measured between the optical axes of two neighboring point light sources belonging to adjacent modules. For example, the external casing of each module has a frame surrounding the plurality of point light sources, the frame having a polygonal perimeter, for example square or hexagonal.

According to a preferred embodiment, each outer casing comprises means for connection to an adjacent module and is configured to keep the optical axes of the point light sources parallel after connection with an adjacent module. The control unit that regulates the power of the light sources of each module is housed in the casing.

Further advantageous characteristics will become more evident from the following description of preferred but not exclusive embodiments, provided purely by way of non-limiting example.

### BRIEF DESCRIPTION OF THE DRAWINGS

The present invention will be described below by means of some preferred embodiments, provided by way of non-limiting example, with reference to the attached drawings. These drawings illustrate different aspects and examples of the present invention and, where appropriate, similar structures, components, materials and/or elements in different figures are indicated by similar reference numerals.

FIG. 1 is an exploded perspective view of the device for testing small bodies in sunlight according to the present invention;

FIG. 2 is a side perspective view of the device for testing small bodies in sunlight according to the present invention;

FIG. 3 is a front perspective view of the device for testing small bodies in sunlight according to the present invention;

FIG. 4 is a side perspective view showing the combination of six devices for testing larger bodies of the single device in sunlight, according to the present invention;

FIG. 5 is a schematic perspective representation of the assembly formed by the device according to the present invention and a small body subjected to testing; and

FIG. 6 is a flowchart of the method for compiling the reference table used according to the present invention.

### DETAILED DESCRIPTION OF THE EMBODIMENTS

Low-cost, low-filament temperature incandescent lamps with a color temperature below 5000K have a radiation spectrum different from that of sunlight which has a temperature of about 6500K outside the earth's atmosphere in the so-called standard conditions AM0, and in particular have a greater component of infrared radiation and a lower component of ultraviolet compared to the sunlight. Consequently, with the same illuminance, which in AM0 conditions is 1366 W/m² while, on the earth's surface, in standard conditions AM1 is 1000 W/m², the light of incandescent lamps has a greater quantity of infrared radiation and a lower quantity of visible light producing significantly different effects than those of the sunlight. In particular, incandescent lights with a light color or temperature lower than 5000K produce, with the same illuminance:
A different heating on colored surfaces and in particular a greater heating of blue or infrared absorbing surfaces, less heating of red or infrared reflecting surfaces and an identical heating of perfectly black surfaces.
A different—usually lower—efficiency of photovoltaic cells, which convert only light energy below a given wavelength into electrical energy.

Taking these aspects into account, the device and the method according to the invention are based on the compensation of the different effect of the light produced by an incandescent lamp with low filament temperature generating, for example through the super/under powering via a dimmer, an amount of light such as to produce, on the illuminated object, the same effects that natural sunlight would produce under the desired conditions (for example AM0, AM 1 or AM1.5) on that same illuminated object.

However, the simple variation of the power supply changes the color temperature, causing an absorption factor different from that at the nominal power of the light source and therefore, alone, does not allow to obtain accurate measurements.

To increase the accuracy of the simulation method, according to the invention proceed as follows.

For any type of measurement (including thermal, photoelectric, chemical) related to the illuminated object, any type of component (e.g., single or triple junction solar cell) or material (e.g., Aluminum, FR4, Carbon or Kapton) and any environmental condition (e.g., AM0, AM1 and AM1.5), a reference solar simulator (e.g., with Xenon lamp) illuminates the material or component under examination and the type of measurement of interest is carried out, in order to detect the effect of interest (e.g., thermal rise, electrical power produced, speed of the chemical reaction, efficiency of conversion of solar energy into electrical energy) to be collected for the reference table.

The same component or material is then illuminated either with the solar simulator of the invention or with another device having an incandescent lamp at a temperature lower than 5000K, and at a known distance from the component and the power supply of this lamp is adjusted so that the effects of the measured illuminance are the same as those measured with the reference solar lamp, e.g., Xenon lamp. It can therefore be asserted that, for that type of measurement, on that type of component, and with those environmental conditions, and at the known distance, the effects of the two simulators are, by construction, identical and therefore precise.

The power parameters of the incandescent lamp at a temperature below 5000K are then stored for each of the combinations indicated above in an appropriate reference table that will be used to adjust the power supply during use for future simulations.

Since it is possible to modify the power supply of incandescent lamps at colors or temperatures below 5000 K, it is possible to illuminate and then perform precise measurements according to the present invention only on a component or device to be measured already present in the reference table, i.e., already tested with a reference solar lamp and whose thermal, chemical, or photoelectric effect is shown in the reference table with the relative over/under power supply value obtained, e.g., via a dimmer. Instead, on components, devices or materials not present in the table, the data in the reference table relating to the component, device or material that most closely resembles the one to be measured will be used to select the proper illumination, but in this case there will be an error in the simulation, which, for the applications, may be contained within acceptable limits.

However, the economic savings obtained are considerable since good results have been found with 12 or 24 V incandescent bulbs with an extremely low cost compared to those used in known simulators, e.g., with Xenon lamps.

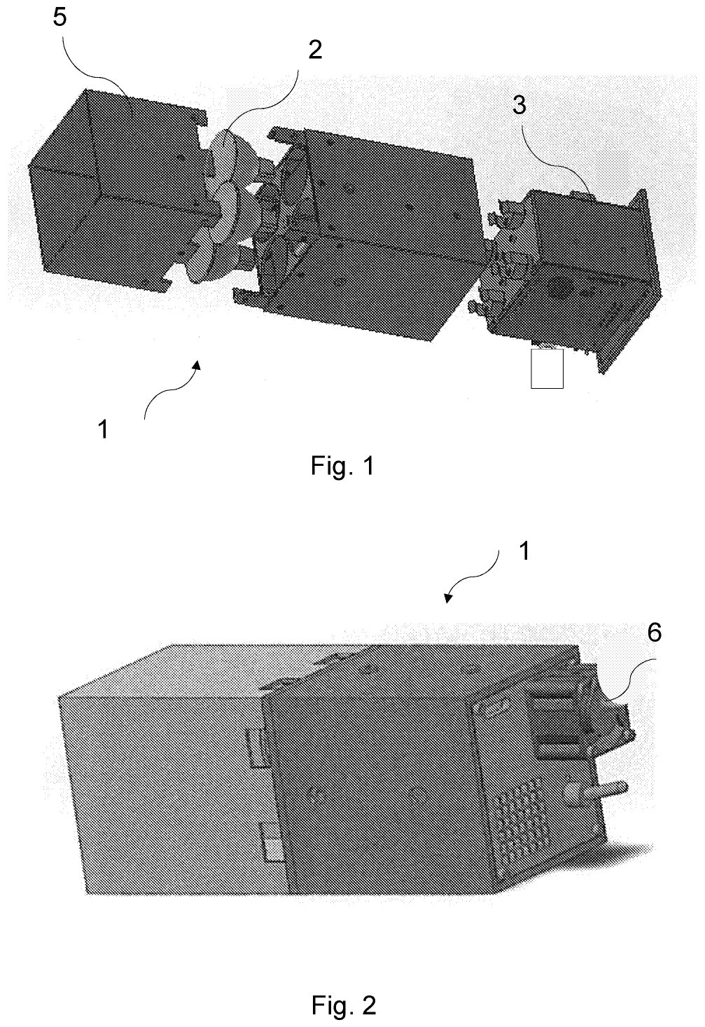

FIG. 1 illustrates as a whole an incandescent lighting device 1 at a temperature below 5000K comprising a light source 2, an electronic control unit 3 of the light source 2, and a reflector 5 for directing the light cone of the source 2. Source 2 can be multiple as illustrated in FIG. 1 or single.

FIG. 2 illustrates the lighting device 1 assembled and equipped with a cooling device 6 to cool the control unit 3 and the lamps or light sources.

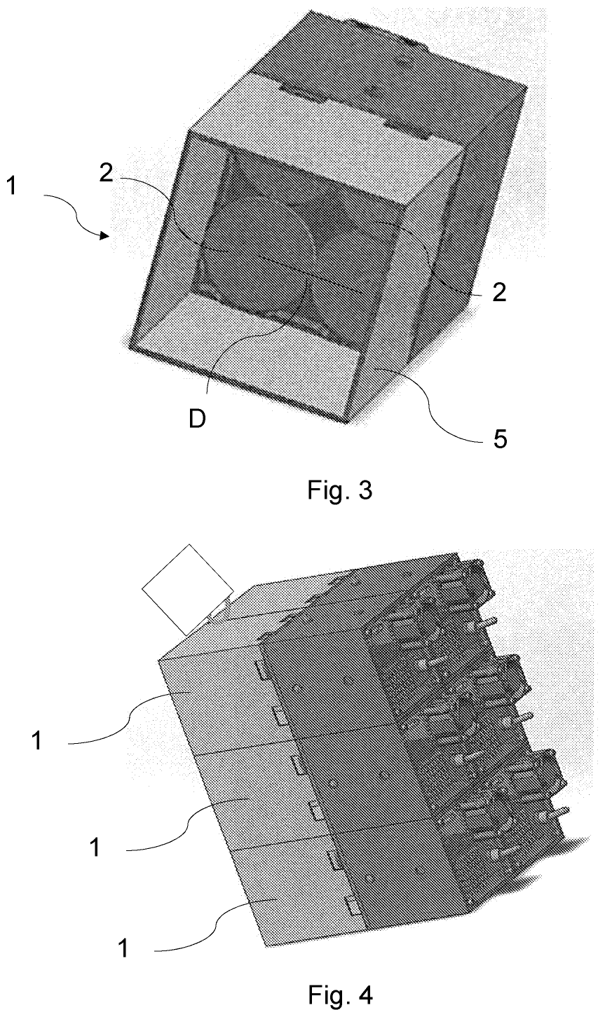

FIG. 3 frontally shows the light source 2 and the reflector 5 which defines, in a direction parallel to the optical axis of the light source 2, a polygonal frame which surrounds the light source 2. In particular, the light source 2 of FIG. 3 is multiple and comprises a plurality of emitters (4 emitters are shown in the figure) arranged according to a module such that, when several devices are side by side, the module is repetitive, and the distance perpendicular to the optical axis between two adjacent emitters of two lighting devices 1 side by side as in FIG. 4 has the same value as that of two corresponding adjacent emitters on board of the same lighting device 1. With reference to FIG. 3, according to a preferred but non-limiting embodiment, the distance D is also measured between the optical axes of two adjacent emitters of two side-by-side lighting devices.

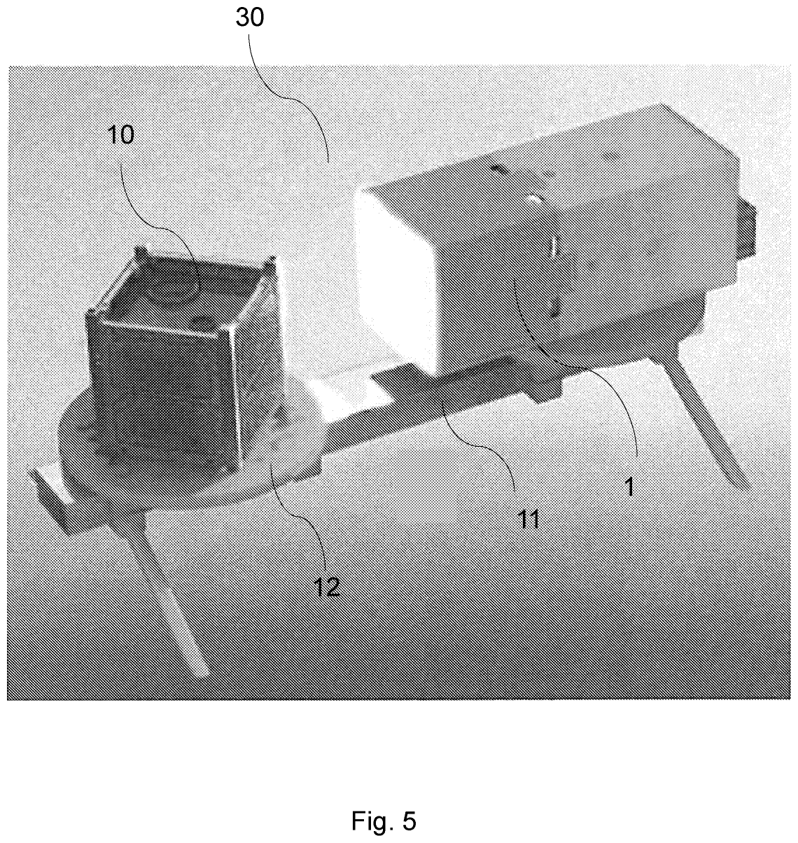

FIG. 5 illustrates a simulation device comprising a lighting device 1, a support 11 on which the lighting device is fixed, and a platform 12 to place an element 10 to be illuminated by the lighting device 1.

It is important to note that the reference table reports power supply voltage values referred to a very precise distance between the element 10 and the lighting source 1 so that, to obtain a precise simulation, the device 30 must be used arranging the body to be illuminated 10 at the same distance as the corresponding body was placed during the preparation of the reference table.

Preferably, control unit 3 can be programmed to simulate the solar rhythms of the day and night (for example with a period of 24 h for terrestrial applications or about 100 min for satellite simulations). It will also be possible to simulate accelerated night/day cycles for thermal stress tests.

According to an explanatory example, during the calibration and preparation of the reference table, a predefined triple junction GaAs solar cell is illuminated with natural sunlight in AM1 conditions, and an electrical power delivered by the photovoltaic cell is measured, from which the efficiency value such as 26% can be eventually derived (the efficiency value is one of the effects included in the reference table). The supply voltage of light source 2 is then adjusted until the same power converted by the solar cell is measured. Consequently, during the calibration phase, the power supply voltage value for light source 2 is stored in the reference table to convert the same electrical power to the solar cell that it converts into real AM1 conditions and, if the solar cell is connected to a conversion or storage circuit, the same electrical effects of the same cell in AM1.

In this way it is possible to carry out a reliable test of a photovoltaic conversion system without resorting to the presence of sunlight on a clear day or without resorting to the use of expensive Xenon arc lamps (typical system used in high-cost simulators). By completing the reference table as above for various types of photovoltaic cells, it is possible to obtain different power coefficients for each type of photovoltaic cell.

Similarly, the thermal power absorbed by a surface, e.g., made of FR4 (material used in electronic technologies, green or blue in color), can be measured when the latter is illuminated by sunlight in standard conditions (through a reference solar generator) and then the power supply voltage of the low-cost light source is adjusted until the thermal power absorbed by the same material equals to that absorbed under the sunlight standard conditions. This voltage value can be used to power the lamp in order to obtain, with low-cost lamps, the same effects as real sunlight, taking into account both the over/under power supply and the change in the color of the light due to the over/underfeeding.

The above procedure is repeated for the other lighting conditions, e.g., AM 0 and AM 1.5 and for each body of which later measurements will be carried out through the illumination by the light source 2. The use of device 30 is based on the assumption that photovoltaic cells with triple junction GaAs different from the one used for the compilation of the reference table have the same behavior as the latter. It has been verified that in most cases, the simulation error when a body different from but similar to the one used to compile the reference table is used leads to measurement errors of a few percent.

The reference table may also include a voltage value associated with completely green, red etc. surfaces. and it is possible to provide an interpolator between these values when, in use, a body is illuminated which shows towards light source 2 a fraction of the red surface and the remaining green fraction. For example, if both fractions are at 50%, in the linear interpolator, it powers the light source at the intermediate power supply value between those present in the reference table for an all green and all red surface (Table I).

TABLE I
(AM1)

| Measure | Element | Material/Color | Electric power |
|---|---|---|---|
| Photovoltaic | Single junction | amorphous Si | 32.3 W |
| Conversion | photovoltaic cell | | |
| Photovoltaic | Single junction | GaAs | 31.9 W |
| Conversion | photovoltaic cell | | |
| Photovoltaic | Triple junction | GaAs | 34.2 W |
| Conversion | photovoltaic cell | | |
| Heating | | red | 30.5 W |
| Heating | | green | 32.1 W |
| Heating | | Red | 34.3 W |
| . . . | . . . | . . . | . . . |

The table shows exemplary power supply values, but it is possible to include further power supply parameters of light source 2, such as for example the power supply.

Based on the foregoing, the preparation of the reference table (s) can be performed manually by adjusting the power supply until the desired value of the effect for which the calibration is performed is obtained.

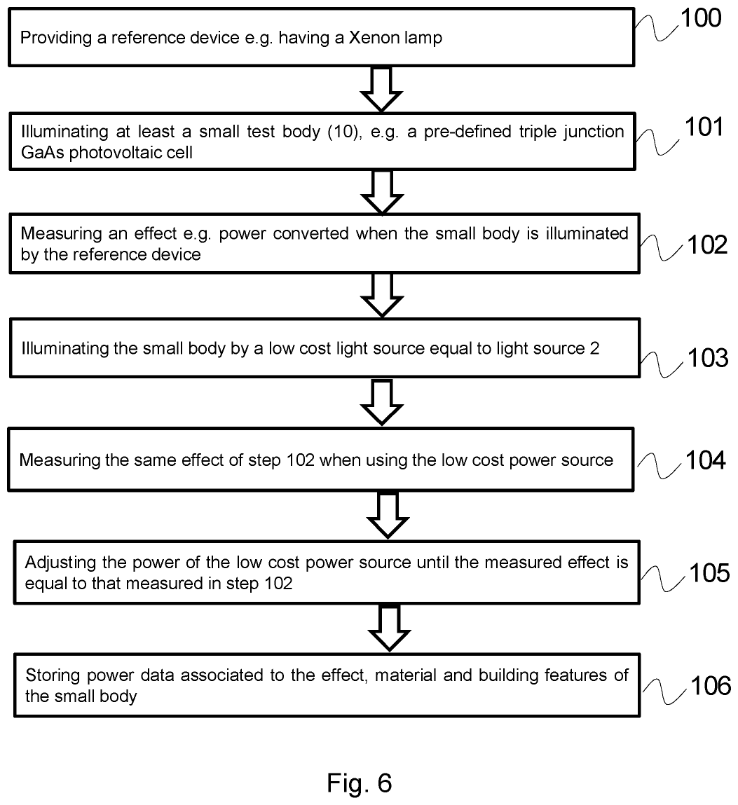

This procedure is substantially illustrated in FIG. 6 including the steps of:

(100) preparing a provided reference lighting device, e.g., Xenon light source, to simulate for example AM0 conditions;

(101) illuminating a small body, e.g., a predefined triple junction cell in GaAs, by the reference lighting device;

(102) measuring an effect, e.g., the converted electrical power;

(103) illuminating the small body with a low-cost light source equal to the source 2 and under the same conditions, e.g., distance, temperature, of step 101;

(104) preparing a sensor of the effect, i.e., the power converted from light energy to electricity, to measure the action of the low-cost light source on the small body;

(105) adjusting the power supply of the low-cost light source until the measurement of the effect is equal to that obtained in the step of illuminating 101;

(106) storing the low-cost light source power data associated with the effect and the physical-chemical-constructive features of the small body, e.g., color, construction materials, type of parameter to be measured, etc. in electronic control unit 3.

When it is necessary to perform a new simulation on the small body using the lighting device 1, for example an endurance test taking into account the day/night alternation, a user will select from the reference table, through a specific user interface, the power supply data of the source 2 on the basis of the effect to be monitored (energy efficiency) and design features of small body (the triple junction solar panel in GaAs). In particular, the control unit can be programmed to display the reference table via the user interface so that the user can select the power supply on the basis of the body and/or the construction characteristics and/or the atmosphere and/or chemical or physical effect to simulate, all of which are shown in the reference table. Alternatively, the control unit receives the data entered by the user through the interface regarding the body on which the simulation is performed and the atmosphere and the chemical or physical effect of interest, and, through known selection and similarity algorithms, the control unit provides the user through the interface with at least a suggestion of power supply of the light source 2 based on the data present in the reference table.

The user interface can be either on board the lighting device 1 or be remote or otherwise separate from the control unit 3 and connected to the latter with or without wires.

Furthermore, the user interface and control unit 3 are configured and programmed to implement a function for regulating the power supply of light source 2 so that steps 103 and 105 can be carried out on board lighting device 1 and not somewhere else.

Advantageously, the user interface and control unit 3 are configured and programmed to implement a function for writing and deleting data in the reference table in order to be able to implement step 106 directly through lighting device 1.

In both cases, lighting device 1 is particularly flexible to be adapted to different activities, such as school activities.

Finally, it is clear that it is possible to make changes or variants to the lighting device described and illustrated here without departing from the scope of protection as defined in the attached claims.

What is claimed is:

1. An illuminating device for testing a small body in sunlight, wherein the small body is a small satellite and the like, and the illuminating device comprises:
at least one incandescent light source at a temperature not exceeding 5000K;
at least one station, receiving light from the at least one incandescent light source and having a support to support the small body;
an electronic control unit, for variable powering of the at least one incandescent light source and comprising at least one electronic processing device, wherein the at least one electronic processing device comprises a microprocessor and a memory device connected in data exchange with the microprocessor; and
a control unit, wherein the control unit is programmed for:
receiving construction data of the small body, first identifying data of a physical or chemical effect to be simulated, second identification data of an atmosphere, and third identifying data of a material or a component to be measured, wherein the second identification data of the atmosphere comprise AM0, AM1, and AM1.5;
storing a pre-defined reference table comprising a list of associations between an equivalent power supply level of the at least one incandescent light source and the construction data, the first identifying data of the physical or chemical effect to be simulated, the second identification data of the atmosphere, wherein the pre-defined reference table reports values of a power supply referred to a pre-defined distance between the small body and the at least one incandescent light source; and
powering the at least one incandescent light source on the basis of a power level present in the pre-defined reference table.

2. The illuminating device according to claim 1, further comprising a parallelepiped frame surrounding the at least one incandescent light source and the control unit for defining a modular configuration, wherein a coupling means is provided to connect parallelepiped frames of two adjacent illuminating devices together.

3. The illuminating device according to claim 2, wherein the at least one station is in common with the parallelepiped frames connected to each other.

4. A system, comprising the illuminating device according to claim 1, wherein the at least one station is mechanically connected to the at least one incandescent light source and to the control unit.

5. An illumination method for testing a small body in sunlight, wherein the small body is placed on a station by an incandescent light source with a temperature not exceeding 5000K, and the illumination method comprises the following steps:
1) providing a pre-defined reference table stored in a control unit of the incandescent light source and filling in so that, for a known distance between the station and the incandescent light source and for each construction characteristic of the small body, each chemical or physical effect to be simulated and atmospheric effect to be simulated, an equivalent power supply value of the incandescent light source is reported;
2) receiving identification data of the small body to be simulated, the chemical or physical effect to be simulated and the atmospheric effect to be simulated;
3) finding a better or exact correspondence between the identification data collected in a receiving phase and at least one constructive characteristic, the chemical or physical effect and the atmospheric effect in the pre-defined reference table;
4) applying to the incandescent light source the equivalent power supply value of the pre-defined reference table corresponding to the best or exact match.

6. The illumination method according to claim 5, wherein step 1 comprises the further preventive steps of:
associating the at least one constructive characteristic to the small body;
measuring a first value of the chemical or physical effect in the atmospheric effect and at the known distance when the small body is illuminated by a light source presenting the solar spectrum;
illuminating the small body with the incandescent light source;
measuring a second value of the chemical or physical effect in the atmospheric effect and at the known distance when the small body is illuminated by the incandescent light source;
adjusting a power supply of the incandescent light source until the second value and the first value are the same;
associating in the pre-defined reference table and storing in the control unit a supply value found in the step of adjusting at the least one constructive characteristic, to the the chemical or physical effect and to the atmospheric effect.

7. The illumination method according to claim 6, wherein an illuminating device comprises a user interface for entering and displaying data for the pre-defined reference table and a user interface for adjusting a supply voltage of the incandescent light source and the further preventive steps are carried out when the small body is on board the illuminating device and through the user interfaces,
wherein the small body is a small satellite and the like, and the illuminating device comprises:
at least one of the incandescent light source at a temperature not exceeding 5000K;
at least one of the station, receiving light from the at least one the incandescent light source and having a support to support the small body;
an electronic control unit, for variable powering of the at least one incandescent light source and comprising at least one electronic processing device, wherein the at least one electronic processing device comprises a microprocessor and a memory device connected in data exchange with the microprocessor; and
the control unit, wherein the control unit is programmed to:
receiving construction data of the small body, first identifying data of the physical or chemical effect to be simulated, second identifying data of the atmosphere, and third identifying data of a material or a component to be measured, wherein the second identifying data of the atmosphere comprise AM0, AM1, and AM1.5;
storing a pre-defined reference table comprising a list of associations between the equivalent power supply level of the at least one incandescent light source and the construction data, the first identifying data of the physical or chemical effect to be simulated, the second identification data of the atmosphere, wherein the pre-defined reference table reports values of a power supply referred to a pre-defined distance between the small body and the at least one incandescent light source; and
powering the at least one incandescent light source on the basis of a power level present in the pre-defined reference table.

8. The system according to claim 4, wherein the illuminating device further comprises a parallelepiped frame surrounding the at least one incandescent light source and the control unit for defining a modular configuration, wherein the modular configuration is coupling means being provided to connect parallelepiped frames of two adjacent illuminating devices together.

9. The system according to claim 8, wherein the at least one station is in common with the parallelepiped frames connected to each other.
